(19) United States
(12) Patent Application Publication
(10) Pub. No.: US 2001/0023617 A1
(43) Pub. Date: Sep. 27, 2001

(54) Axial actuator

(76) Inventor: Karl Diemer, Idstein/Heftrich (DE)

Correspondence Address: Harness, Dickey & Pierce, P.L.C., P.O. Box 828, Bloomfield Hills, MI, 48303, US

(21) Appl. No.: 09/756,475

(22) Filed: Jan. 8, 2001

Related U.S. Application Data
(63) Continuation of application No. PCT/EP99/03762, filed on May 31, 1999.

(30) Foreign Application Priority Data
Jul. 9, 1998 (DE) DE19830822.1

(51) Int. Cl. F16H 27/02; F16H 29/02

(52) U.S. Cl. 74/89

(57) ABSTRACT

Proposed is an axial adjuster having at least a first pair of helical raceways (322a) extending rotatable about an axial axis (A) along a cylindrical shell (36) wherein arranged between the first pair of helical raceways is a radially guided axial needle or roller ring whose running length corresponds substantially to the length of the raceways, at least one second pair of helical raceways (322i) possibly being provided arranged relative to said first pair (322a) radially outwards or inwards and along the cylindrical shell (36) 180° out of phase to the first pair, between the raceways a radially guided axial needle or roller ring being arranged whose running length corresponds substantially to the length of the raceways.

### FIELD OF THE INVENTION

The invention relates to an axial actuator or adjuster having at least one pair of helical raceways extending rotatable about an axial axis along a cylindrical shell. Such axial adjusters find application, for example, in transmissions, brakes, clutches, differentials, clamps, presses and the like.

### BACKGROUND OF THE INVENTION

Axial adjusters are put to use when a rotary movement needs to be translated into a longitudinal movement, also in a cramped space where very high forces are involved. Axial adjusters feature helical raceways facing each other in a paired sliding friction arrangement for rotating about an axial axis along a cylindrical shell The raceways constitute ramps wrapped around a centerline. An opposing movement of these two “ramps”, i.e. an opposing rotation of the two helical raceways in the present case, results in the raceway-incorporating bodies moving relative to each other in approaching each other or moving away from each other. Thus, a minor rotation over the ramped helix achieves an axial movement permitting corresponding shifting or stroke travel. The system as described is known from prior art but is limited as regards its wear resistance and power transmission capacity. Apart from this its range of application is restricted due to the tilting forces becoming all the more the greater the angle of rotation.

### SUMMARY OF THE INVENTION

The object of the invention is to provide an axial actuator (adjuster) permitting optimum axial loading capacity and freedom of movement for minimum outer dimensions in avoiding or at least diminishing prior art disadvantages as described.

This object is achieved by an axial adjuster as it reads from FIG. 1. An axial adjuster designed as such in accordance with the invention permits freedom of movement in rotation of the helical raceways relative to each other and a correspondingly high power handling capacity.

In one advantageous aspect of the invention the axial adjuster is configured so that to the first pair of helical raceways a second pair of helical raceways is arranged staggered radially outwards or inwards relative to the first pair, a radially guided axial needle or roller ring likewise being arranged between these raceways whose running length likewise substantially corresponds to the running length of the raceways. The particular major advantage afforded by this aspect in accordance with the invention is the greatly increased range of angular twist permitted under load since due to the second raceway pair being 180° out of phase to the first pair tilting forces are practically eliminated in excluding tilting. The axial needle or roller rings put to use in the axial adjusters as described enable very high axial forces to be generated as a result of the rolling friction due to the very low twisting forces, thus enabling efficiency to be optimized and hysteresis losses to be minimized. The axial forces depend on the slope of the helical raceways (ramps) and in this case are limited only by the admissible surface pressure of the roller bodies at the points of contact (line contact) of the raceways. Due to the ramps being arranged as mentioned concentrically nested and/or 180° out of phase an axial-parallel movement of the companion part is producing without tilting when twisted. When the rotary movement is limited to advantage to half the theoretically possible angular range, sufficient axial force transmission and resistance to tilting is still assured.

In another advantageous aspect of the invention the axial needle or roller rings may be commercially available rings radially split and having the length of the cited running length, the cages of the roller rings being correspondingly split to thus permit achieving cost-effective axial adjusters with no particular complication.

In yet another advantageous aspect of the invention several axial adjusters are arranged in series, this series arrangement decidingly elongating the adjustment travel.

The ramped segments can also be produced cost-effectively as helical skew planes, including preferably either a radially split arrangement of cages in series or are designed easily modified from parts in series. Still another aspect of the invention consists of the raceway-incorporating cylindrical bodies extending substantially circularly rotatable about an axial axis being guided by plain or roller bearings e.g. also ball cages, resulting in added freedom of movement of the adjuster whilst enhancing the resistance to tilting with optimum centering.

### BRIEF DESCRIPTION OF THE DRAWINGS

The invention will now be detailled with reference to the drawing in which:

FIG. 1 is a schematic view in perspective of a helical raceway arranged on a lower part of an axial adjuster.

FIG. 2 is an illustration of the upper part belonging to the lower part as shown in FIG. 1.

FIG. 3 is a schematic view in perspective of a lower part similar to that as shown in FIG. 1 but including two concentric helical raceways.

FIG. 4 is a section view illustrating an axial adjuster employing the lower part as shown in FIG. 3.

FIG. 5 is a plan view of the lower part as shown in FIG. 1.

### DETAILLED DESCRIPTION

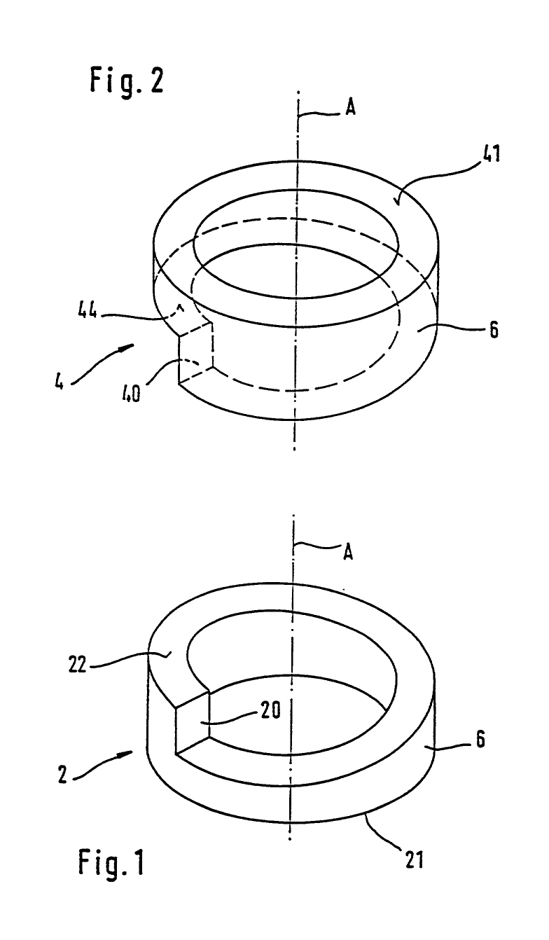

Referring now to FIG. 1 there is illustrated schematically a lower part 2 of an axial adjuster 1 in the form of a ring comprising a cylindrical shell 6 extending concentrically about an axis A. Clearly evident is a raceway 22 extending from the lower edge of a vertical step 20 (in this illustration) counter-clockwise helically along the circumference 6 of the lower part 2 about the vertical axis A and ending at the upper end of the step 20, the raceway 22 runs full-circle, i.e. 360°.

Referring now to FIG. 2 there is illustrated the upper part 4 corresponding to the lower part 2 as shown in FIG. 1 including a helical raceway 44 running analogously to the raceway 22 and (in this illustration) downwards. The raceway 44 is not directly evident, this being the reason why it is indicated by the broken line. Arranged in accordance with the invention between the two raceways 22 and 44—which when running around the same axis A are always equidistant and thus running in parallel—is an axial roller ring 8 (see e.g. FIG. 4) split at a point radially in the region between two pockets so that it essentially assumes the helical shape corresponding to the raceways 22 and 24. When a corresponding axial roller ring 8 is inserted between the two raceways 22 and 24 the upper part 4 can be rotated on the lower part 2 (in this aspect) counter-clockwise, resulting in the upper part 4 being axially moved away from the lower part 2. In this arrangement the axial roller ring 8 always covers half the rotation of the upper part 4 relative to the lower part 2. The return rotation of the upper part 4 relative to the lower part 2 occurs analogously counter-clockwise, simultaneously resulting in the two parts approaching each other, and ends finally in the starting position. Moving away and approaching in this case is understood to relate, of course, to the bottom surfaces 21 and 41 of upper part 4 and lower part 2 respectively arranged at right angles to the vertical axis A in the case of the parts as just described. By way of the parts as shown in FIGS. 1 and 2 the arrangement of the helical raceways relative to each other with an interposed axial needle or roller ring will now be explained in principle.

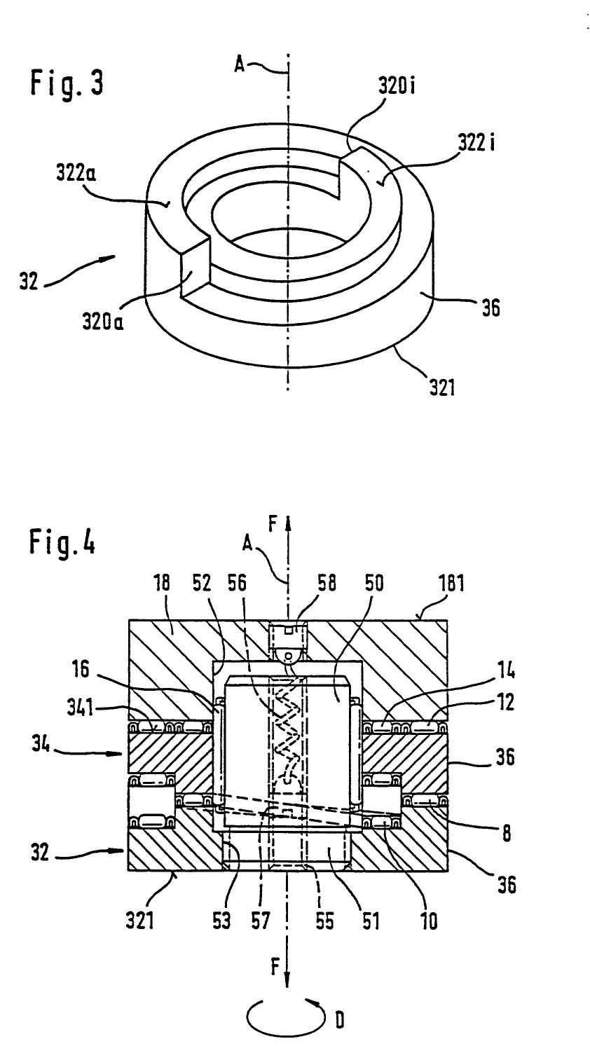

Referring now to FIG. 3 there is illustrated a lower part 32 used in an advantageous aspect of the invention, whereby in this case two concentric helical raceways 322a and 322i are evident, each of which start and end in contact with the stepped surfaces 320a and 320i. The special feature in the example embodiment as shown in FIG. 3 as compared to the arrangement of the helical raceways as shown in FIGS. 1 and 2 is that in the example embodiment as shown in FIG. 3, due to the helical raceways 322i and 322a being 180° out of phase, practically no tilting moments of force occur when the upper part is rotated relative to the lower part.

Referring now to FIG. 4 there is illustrated schematically in section by way of example how an upper part 34 analogous to the upper part 4 as shown in FIG. 2 is arranged with two concentric helical raceways above the lower part 32 as just described, helically formed axial roller rings 8 and 10 likewise being interposed inbetween. It is to be noted that the illustration as shown in FIG. 4 is not true to scale, i.e. it merely being intended to explain in principle the assignment of the individual components. Other details too of the example as shown in FIG. 4 such as hub, spring, bolts and threads are cited merely to explain a function model, they not constituting part of the invention.

Arranged on the upper annular bottom surface 341 of the upper part 34 are axial needle or roller bearings 12 and 14 axially supporting and carrying a thrust flange 18 against the upper part 34. In the interior of lower part 32 and upper part 34 a substantially cylindrical hub 50 is arranged whose cylindrical outer wall represents the raceway of a radial needle bearing 16 whilst the outer raceway for the radial needle bearing 16 results from the inner cylindrical shells of lower part 32, upper part 34 and a blind hole-type recess 52 of the thrust flange 18. The radial needle bearing 16 in the example embodiment as shown in FIG. 4 is arranged in the inner portion of the upper part and lower part. Just as possible is an arrangement in which upper and lower part are surrounded and centered by a radial needle bearing.

In its lower end portion as shown in FIG. 4 the hub 50 is provided with a screw flange 51 provided with a male thread which in the present example embodiment is screwed into a female thread 53 arranged in the lower part 32. Evident in the central portion of the hub 50 is a full-length female thread 55 into which an eye bolt 57 articulatedly connected to a spring 56 is screwed. In the middle of the thrust flange 18 facing upwards away from the axial adjuster an eye bolt 58 corresponding to the eye bolt 57 is screwed in suspended in the aforementioned spring 56. As already evident from the drawing this is a coil traction spring 56, by means of which the axial adjuster can be maintained with zero clearance.

The device as described functions as follows: the upper part 34 arranged between thrust flange 18 and lower part 32 is turned in the direction of the arrow D so that it is moved away from the lower part 32 and splays the thrust flange 18 from the lower part 32 in the direction of the arrow F and thus overcomes the force of the spring 56. When the upper part 34 is turned back in the opposite direction thrust flange 18 and lower part 32 again approach each other. The axial roller rings 12 and 14 prevent the thrust flange 18 being included in turning with the upper part 34. The parts of the device to be splayed are expediently arranged on the thrust surfaces 321 (lower part 32) and thrust surface 181 (thrust flange 18) opposing each other. It is to be noted that the proportions of the example embodiment as shown in FIG. 4 can be varied in many respects in adapting them to the particular case as required. Thus, the thrust flange, for example, may be just a rotor or axial disk.

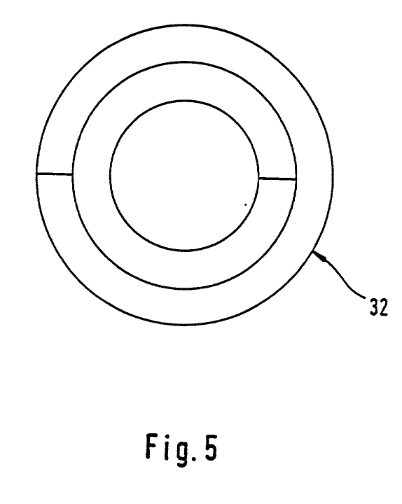

The arrangement or also the number of the helical raceways can be selected as required. Referring now to FIG. 5 there is illustrated in a plan view the lower part 32 as described more particularly in FIGS. 3 and 4. In this arrangement two helical raceways are arranged concentrically 180° out of phase.

The axial adjuster (actuator) in accordance with the invention has a wealth of applications. One possible application is vehicle clutch release/application (e.g. via central actuation by an electric motor) possibly eliminating the complete pedal mechanics of the clutch. The axial adjuster in accordance with the invention finds likewise application in disk brakes, i.e. for solenoid brake actuation as well as in a parking brake. Likewise feasible is its application in shifting gears or axial plate engagement or in automatic transmissions, brakes or clutches as well as in differentials. Further fields of application relate to axial shaft shifting, clamping elements and presses. The advantages attained therewith as compared to solutions known hitherto include a simple mechanical configuration, extremely low-profile design, freedom of movement for high efficiency and low hysteresis losses, the aforementioned high axial loading capacity and translation of a rotary movement into a translatory movement with minimum space requirement and—when sloping the helical raceways correspondingly steep—also vice-versa.

The individual components of the axial adjuster can be manufactured with no appreciable difficulty. Thus, the concentrically nested, substantially annular helical raceways of the ramps may be machined or also produced as extruded or sintered parts, where necessary, also as high strength diecastings.

Expediently the axial needle or roller rings are radially split at a pocket and axially splayed depending on the pitch. For very steep sloping a plastics cage could be correspondingly injection molded, where necessary.

What is claimed is:

1. An axial adjuster including an upper part (4) and a lower part (2) arranged twistable relative to each other and each comprising at least one first helical raceway (44, 22), said raceways (44,22) pointing to each other extending about an axial axis along a cylindrical shell (6) wherein arranged between said at least two raceways (44, 22) is a radially guided axial needle ring or axial roller ring (8) whose running length corresponds substantially to the length of said raceways.

2. The axial adjuster as set forth in claim 1 comprising at least one further pair of second helical raceways arranged relative to said first raceways (44, 22) radially outwards or inwards and along the cylindrical shell 180° out of phase to said first raceways (44, 22), between said at least second raceways a second radially guided axial needle ring or axial roller ring (10) being arranged, whose running length corresponds substantially to the length of said second raceways.

3. The axial adjuster as set forth in claim 1 or 2 wherein said axial needle or roller ring(s) (8, 10) are commercially available rings radially split and having the length of the cited running length.

4. The axial adjuster as set. forth in claim 1, 2 or 3 wherein said upper part and said lower part extending substantially circularly rotatable about said axial axis, are radially guided by rolling bearings (16).

5. The axial adjuster as set forth in any of the preceding claims said upper part and said lower part extending substantially circularly rotatable about an axial axis are connected axially via an elastic traction means (56).

6. An axial adjuster comprising a series arrangement of several axial adjusters as set forth in any of the preceding claims.
